(19) United States
(12) Patent Application Publication
(10) Pub. No.: US 2010/0009641 A1
(43) Pub. Date: Jan. 14, 2010

(54) DIGITAL RF PHASE CONTROL IN POLAR MODULATION TRANSMITTERS

(75) Inventors: Saleh Osman, Cupertino, CA (US); Wayne S. Lee, San Mateo, CA (US); Earl W. McCune, JR., Santa Clara, CA (US)

Correspondence Address: SNELL & WILMER L.L.P. (Panasonic), 600 ANTON BOULEVARD, SUITE 1400, COSTA MESA, CA, 92626, US

(73) Assignee: Matsushita Electric Industrial Co.,Ltd.

(21) Appl. No.: 12/172,125

(22) Filed: Jul. 11, 2008

(51) Int. Cl. H04B 1/04

(52) U.S. Cl. 455/102

(57) ABSTRACT

An exemplary modulator apparatus for a polar modulation transmitter includes a phase difference extractor, a phase modulator, and a coarse phase controller. The phase difference extractor is configured to extract +180° and −180° phase differences represented in a phase-difference modulation signal in a phase modulation path of the polar modulation transmitter, or extract other phase differences exceeding other predetermined phase difference thresholds, to produce a bandwidth-reduced phase-difference modulation signal. The phase modulator includes a controlled oscillator having a tuning port that is modulated by phase differences represented in the bandwidth-reduced phase-difference modulation signal, to produce a phase-modulated RF carrier signal. The coarse phase controller operates to effectuate phase reversals or introduce other coarse phase changes into the phase-modulated RF carrier signal, based on the phase differences extracted from the original phase-difference modulation signal.

### FIELD OF THE INVENTION

The present invention relates to communications transmitters. More specifically, the present invention relates to methods and apparatus for controlling phase modulation in polar modulation transmitters.

### BACKGROUND OF THE INVENTION

One of the most difficult challenges in the design of a wireless communications device is the design of the device's radio frequency (RF) transmitter. Conventional RF transmitter architectures are based on what is known as a quadrature (or “IQ”) modulator. The quadrature modulator modulates information to be transmitted onto an RF carrier signal, which then carries the information through the atmosphere to a remote receiver, such as an access point of a wireless local area network or a basestation of a cellular network.

FIG. 1 is a block diagram of a typical quadrature-modulator-based transmitter 100. The quadrature-modulator-based transmitter 100 comprises a symbol generator 102; first and second digital-to-analog converters (DACs) 104 and 106; a quadrature modulator 108 including an in-phase channel (I-channel) mixer 110, quadrature phase channel (Q-channel) mixer 112, 90° phase shifter 114, and summer 116; a surface acoustic wave filter (SAW) 118; a power amplifier (PA) 120; and an antenna 122.

The symbol generator 102 operates to form orthogonal I-channel and Q-channel sequences of symbols from a digital message to be transmitted. The first and second DACs 104 and 106 convert the I- and Q-channel sequences of symbols to analog I-channel and Q-channel signals. The quadrature modulator 108 modulates the analog I-channel and Q-channel signals onto orthogonal RF carrier signals generated by a local oscillator 124 and 90° phase shifter 114. In other words, the I-channel mixer 110 modulates the analog I-channel signal onto an in-phase RF carrier signal, while the Q-channel mixer 112 modulates the analog Q-channel signal onto a 90° phase shifted version of the in-phase RF carrier signal. The summer 116 combines the upconverted I- and Q-channel signals and couples the summed result to an input of the SAW filter 118, which operates as a bandpass filter. Finally, the bandpass-filtered signal is amplified by the PA 120 and radiated over the air by the antenna 122 to a remote receiver.

One desirable characteristic of the quadrature-modulator-based transmitter 100 is that the frequency or phase of the RF carrier signal can be modulated simply by manipulating the amplitudes of the I- and Q-channel signals. However, a significant limitation of the quadrature-modulator-based transmitter 100 is that it is not very power efficient. In an effort to increase spectral efficiency, many state-of-the-art communications systems employ nonconstant-envelope signals. To prevent clipping of the signal peaks of these nonconstant-envelope signals in the quadrature-modulator-based transmitter 100, the signal levels must be reduced before being introduced to the transmitter's PA 120, and the PA 120 must be configured to operate in its linear region of operation. Unfortunately, linear PAs configured to operate at reduced drive levels are not very power efficient. This lack of power efficiency is a major concern, particularly in battery-powered applications such as, for example, cellular handsets.

The linearity versus power efficiency trade-off of the quadrature-modulator-based transmitter 100 can be avoided by using an alternative type of communications transmitter known as a polar modulation transmitter. A polar modulation transmitter converts the rectangular-coordinate I and Q signal into polar-coordinate amplitude and phase-difference modulation signals ρ and Δθ. As explained below, this affords the ability to operate the polar modulation transmitter's PA in its nonlinear region where it is much more efficient at converting DC power to RF power than when configured to operate in its linear region.

FIG. 2 is a simplified drawing of a typical polar modulation transmitter 200. The polar modulation transmitter 200 comprises a baseband processor 202; a rectangular-to-polar converter 204; an amplitude modulator 206 configured in an amplitude path; a phase modulator 208 including a phase-locked loop (PLL) 210 and voltage-controlled oscillator (VCO) 210 configured in a phase path; a PA 214; and an antenna 216.

During operation, the baseband processor 202 generates digital rectangular-coordinate I and Q signals from a digital message to be transmitted. The rectangular-to-polar converter 204 converts the digital I and Q signals into digital polar-coordinate amplitude and phase-difference modulation signals ρ and Δθ. The amplitude modulator 206 modulates a DC power supply Vsupply according to amplitude variations represented in the digital amplitude modulation signal ρ. The resulting amplitude modulated power supply signal is coupled to the power supply port of the PA 214. Meanwhile, the phase modulator 208 modulates an RF carrier signal generated by the VCO 212 in accordance with frequency variations represented in the phase-difference modulation signal Δθ. The PLL 210 generates a tuning voltage Vtune signal having a time varying magnitude representing the degree to which the frequency represented in the phase-difference modulation signal Δθ deviates from the center frequency of the VCO 212. The VCO 212 operates as an integrator, responding to the tuning voltage Vtune from the PLL 210 to produce a constant-envelope phase-modulated RF carrier signal containing the desired phase modulation.

Because the phase-modulated RF carrier signal has a constant envelope, the PA 214 can be configured to operate in its nonlinear region of operation, where it is efficient at converting DC power from the DC power supply Vsupply to RF power at the output of the PA 214. Typically the PA 214 is implemented as a Class D, E or F switch-mode PA 214 operating in compression, so that the output power of the PA 214 is directly controlled by the amplitude modulated power supply signal applied to the power supply port of the PA 214. Effectively, the PA 214 operates as an amplitude modulator, amplifying the constant-envelope phase-modulated RF carrier signal according to amplitude variations in the amplitude modulated power supply signal to produce the desired amplitude- and phase-modulated RF carrier signal.

In addition to the benefit of being power efficient, another desirable characteristic of the polar modulation transmitter 200 is that its baseband functions can be designed entirely from digital circuits. A digital implementation is favored over an analog implementation since a digital implementation lends itself to being fabricated using standard high-yield integrated circuit manufacturing processes. A digital approach is also favorable since it allows the use of digital signal processing techniques, which are capable of generating and processing modulation signals of different modulation standards entirely within the digital domain. This allows the same radio architecture to be used for multiple standards, thereby making the polar modulation transmitter well-suited for multimode designs. Multimode capability is not so easily achieved in quadrature-modulator-based transmitters, since multiple upconverting mixers must usually be used to accommodate the different frequency bands of the multiple standards. Further, each upconverting mixer must be followed by its own dedicated narrowband SAW filter, in order to attenuate the spurious signals generated by each of the different mixers and to drive the noise floor down to acceptable levels.

Although the polar modulation transmitter 200 offers a number of performance advantages over the more conventional quadrature-modulator based transmitter 100, the bandwidths of the amplitude and phase-difference modulation signals ρ and Δθ are typically higher than when the modulation is expressed in rectangular coordinates. This so-called “bandwidth expansion,” which occurs in the conversion of the modulation from rectangular to polar coordinates, can be problematic in polar modulation transmitters since the rate at which the amplitude and phase-difference modulation signals ρ and Δθ signals must be processed depends on their respective bandwidths. If the bandwidth expansion exceeds the processing rate capabilities of the polar modulation transmitter's digital signal processing hardware the polar modulation transmitter 200 can be rendered essentially inoperable.

The bandwidth of the phase-difference modulation signal Δθ, in particular, determines how fast the polar modulator's VCO 212 must operate. If the bandwidth exceeds the linear tuning range capability of the VCO 212, the VCO 212 is forced to operate in its nonlinear region. This compromises the modulation accuracy of the polar modulation transmitter 200, making it difficult, or in some cases even impossible, to comply with noise limitation requirements of wireless communications standards.

The level of bandwidth expansion that occurs in the conversion from rectangular to polar coordinates depends in large part on the modulation format used. Many existing technologies such as orthogonal frequency division multiplexing (OFDM), and other existing or soon-to-be deployed cellular technologies, such as W-CDMA, High-Speed Packet Access (HSPA) and Long Term Evolution (LTE) technologies, employ nonconstant-envelope modulation formats that produce signal trajectories passing through (or very close to) the origin in the I-Q signal plane, as illustrated in FIG. 3. When represented in polar coordinates these types of signals have very wide phase difference bandwidths. In fact, for modulation formats that do generate signal trajectories that pass through the origin, instantaneous phase changes of 180° occur. These instantaneous phase changes correspond to high frequency content that exceeds the digital signal processing and VCO linear tuning range capabilities of the polar modulation transmitter 100.

It would be desirable, therefore, to have methods and apparatus for processing wideband signals in a polar modulation transmitter that do not result in a high level of modulation errors or adjacent channel signal distortion.

### SUMMARY OF THE INVENTION

Polar modulation methods and apparatus with digital radio frequency (RF) phase control are disclosed. An exemplary modulator apparatus for a polar modulation transmitter includes a phase difference extractor, a phase modulator, and a coarse phase controller. The phase difference extractor is configured to extract +180° and −180° phase differences represented in a phase-difference modulation signal in a phase modulation path of the polar modulation transmitter, or extract other phase differences exceeding other predetermined phase difference thresholds, to produce a bandwidth-reduced phase-difference modulation signal. The phase modulator includes a controlled oscillator having a tuning port that is modulated by phase differences represented in the bandwidth-reduced phase-difference modulation signal, to produce a phase-modulated RF carrier signal. The coarse phase controller operates to effectuate phase reversals, or introduce other coarse phase changes into the phase-modulated RF carrier signal, based on the phase differences extracted from the original phase-difference modulation signal. Because the bandwidth of the bandwidth-reduced phase-difference modulation signal is substantially less than the bandwidth of the original phase-difference modulation signal, the polar modulation transmitter is able to react to and operate on wideband phase-difference modulation signals without requiring the controlled oscillator to operate in its nonlinear tuning region.

Further features and advantages of the present invention, including a description of the structure and operation of the above-summarized and other exemplary embodiments of the invention, are described in detail below with respect to accompanying drawings, in which like reference numbers are used to indicate identical or functionally similar elements.

### BRIEF DESCRIPTION OF THE DRAWINGS

FIG. 1 is a block diagram of a typical quadrature-modulator-based radio frequency (RF) transmitter;

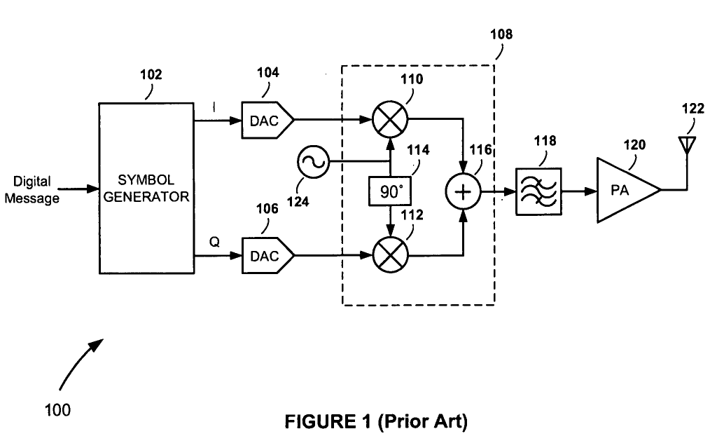

FIG. 2 is a simplified drawing of a typical polar modulation transmitter;

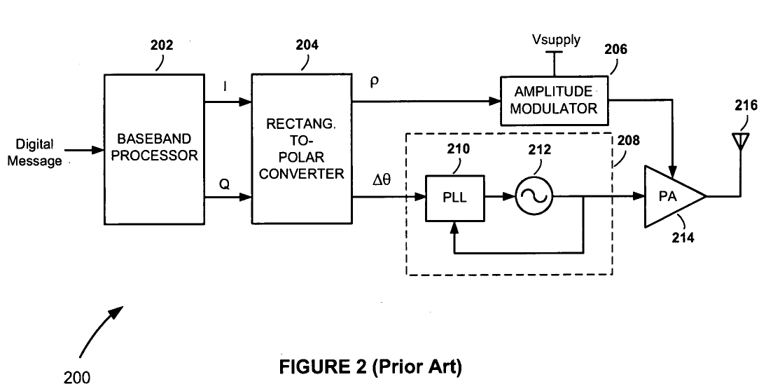

FIG. 3 is a drawing illustrating how the signal trajectory of a signal modulated according to a nonconstant-envelope modulation format can pass through the origin in the I-Q signal plane;

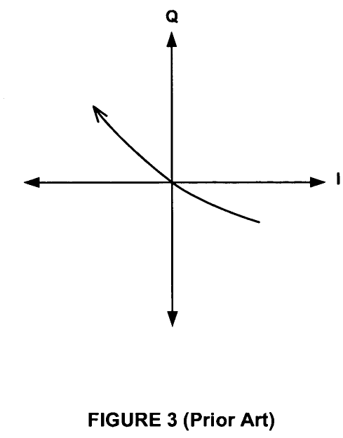

FIG. 4 is a drawing of a polar modulation transmitter adapted to include digital RF phase control, according to an embodiment of the present invention;

FIG. 5 is a drawing of a coarse phase controller having a quadrature local oscillator generator that can be used to implement the coarse phase controller of the polar modulation transmitter in FIG. 4;

FIGS. 6A-C are simplified timing diagrams of a phase-difference modulation signal Δθ (FIG. 6A), a bandwidth-reduced phase-difference modulation signal Δθ (FIG. 6B), and a phase toggle control signal (FIG. 6C), illustrating fine and coarse phase control of the phase-difference modulation signal Δθ when the coarse phase-difference thresholds are set at +90° and −90;

FIG. 7 is a drawing illustrating how the polar modulation transmitter in FIG. 4 can be adapted to include a digital power controller and digital power ramp generator, according to an embodiment of the present invention;

FIG. 8 is a drawing illustrating how the amplitude of the RF power applied to the RF input of the power amplifier of the polar modulation transmitter in FIG. 7 is temporarily reduced during a switching event of the coarse phase controller; and

FIG. 9 is a drawing illustrating how, in addition to (or as an alternative to) the digital power control in the phase modulation path in FIG. 7, the polar modulation transmitter in FIG. 4 is adapted to include power control in the amplitude modulation path.

### DETAILED DESCRIPTION

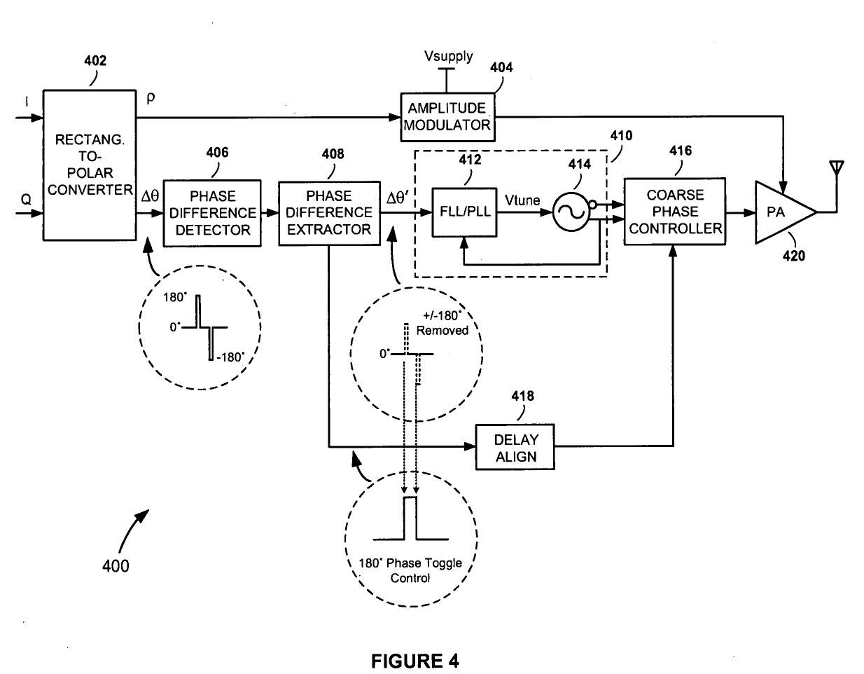

Referring to FIG. 4, there is shown a polar modulation transmitter 400, according to an embodiment of the present invention. The polar modulation transmitter 400 comprises a rectangular-to-polar converter 402; an amplitude modulation (AM) path including an amplitude modulator 404; a phase modulation (PM) path including a phase difference detector 406, phase difference extractor 408, phase modulator 410 including a frequency-locked loop or phase-locked loop (FLL/PLL) 412, and voltage controlled oscillator (VCO) 414; a coarse phase controller 416; a coarse phase control feedforward path including a delay align block 418; and a power amplifier (PA) 420.

The rectangular-to-polar converter 402 functions to convert in-phase (I) and quadrature (Q) phase sequences of symbols into digital amplitude and phase-difference modulation signals ρ and Δθ using, for example, a CORDIC (Coordinate Rotation Digital Computer) algorithm. The digital amplitude modulation signal ρ represents sample-to-sample changes in the envelope of the modulation, and the digital phase-difference modulation signal Δθ represents sample-to-sample changes in the phase (i.e., phase differences) of the modulation.

In the AM path, the amplitude modulator 404 operates to modulate a direct current (DC) power supply signal Vsupply according to amplitude variations represented in the amplitude modulation signal ρ. The resulting amplitude modulated power supply signal is used to modulate the drain (or collector) input of the PA 420, similar to as in the conventional polar modulation transmitter 100 described above.

In the PM path, the phase difference detector 406 operates to detect phase differences in the phase-difference modulation signal Δθ of either +180° or −180° (or, as explained below, some other phase differences). The phase difference extractor 408 responds to the +180° and −180° phase differences detected by the phase difference detector 406 by extracting the +180° and −180° phase differences from the phase-difference modulation signal Δθ, thereby producing a bandwidth-reduced phase-difference modulation signal Δθ″.

The phase difference extractor 408 is further operable to generate and control the level of a phase toggle control signal that is fed forward along the coarse phase control feedforward path to a control input of the coarse phase controller 416. The coarse phase controller 416 operates to reintroduce the previously extracted +180° and −180° phase differences into the radio frequency (RF) signal appearing at the output of the VCO 414. The delay align block 418 in the coarse phase control feedforward accounts for the delay of the phase modulator 410 in the main path, thereby ensuring that toggling of the phase toggle control signal is performed at the appropriate time. According to one embodiment, the coarse phase controller 416 comprises a 2-1 multiplexer having first and second inputs coupled to a differential output of the VCO 414. When implemented in this manner, the coarse phase controller is able to introduce a phase reversal in the RF signal appearing at the output of the VCO 414, simply by switching from one output phase of the differential output to the counter phase.

Whereas the extracted +180° and −180° phase differences are used to provide coarse phase control at the output of the VCO 414, the remaining phase differences represented in the bandwidth-reduced phase-difference modulation signal Δθ′ are used to provide fine phase control of the RF carrier signal generated by the VCO 414. Specifically, the bandwidth-reduced phase-difference modulation signal Δθ′ is coupled to the input of the phase modulator 410, which functions as a fine phase controller, modulates the tuning input of the VCO 414 according to the phase differences represented in the bandwidth-reduced phase-difference modulation signal Δθ′. Phase accuracy is achieved by the phase reversals performed by the coarse phase controller 416 at the output of the VCO 414.

The phase modulator 410 may be implemented in a variety of different ways. According to one embodiment, it is configured as a two-point modulator containing an FLL or PLL having a main control loop and an auxiliary modulation path for injecting the bandwidth-reduced phase-difference modulation signal Δθ′ into the tuning port of the VCO 414. Note that the label “FLL/PLL” is used in FIG. 4 to indicate that either a FLL-based phase modulator 410 or a PLL-based modulator may be used.) The two-point phase modulator may be implemented in a variety of different ways. Some exemplary two-point phase modulators that may be used are shown and described in U.S. Pat. No. 5,952,895 to McCune et al. and U.S. Pat. No. 6,094,101 to Sander et al. and in W. B. Sander et al., Polar Modulator for Multi-Mode Cell Phones, Custom Integrated Circuits Conference, Proceedings of the IEEE 2003, 21-24 Sep. 2003, pp. 439-445, which are hereby incorporated by reference. The two-point phase modulators in these references employ an FLL and a high-speed auxiliary modulation path. When configured in the polar modulation transmitter 400 in FIG. 4, the bandwidth-reduced phase-difference modulation signal Δθ′ is passed through the main control loop of the FLL/PLL 412, and also fed forward along the high-speed auxiliary modulation path and injected into the tuning port of the VCO 414, bypassing the FLL/PLL 412. Direct digital synthesis of the bandwidth-reduced phase-difference modulation signal Δθ′ and frequency-to-digital conversion of the VCO 414 output frequency in the feedback path of the FLL/PLL 412 are used to minimize the frequency error between the phase differences represented in the bandwidth-reduced phase-difference modulation signal Δθ′ and the VCO output frequency.

The polar modulation transmitter 400 provides a number of advantages and benefits over conventional polar modulation transmitters. First, removing the large +180° and −180° phase differences from the phase-difference modulation signal Δθ results in a bandwidth-reduced phase-difference modulation signal Δθ′ having a substantially lower bandwidth. The reduced bandwidth ensures that the VCO 414 is not tuned beyond its linear tuning range. Second, the reduced bandwidth eliminates (or at least substantially reduces) the need for complex VCO linearization and calibration processes, which might otherwise be needed to counter nonlinear operation of the VCO 414. Third, the fine and coarse phase operations and controls are digitally implemented, thereby allowing the design to be manufactured in integrated circuit form using standard high-yield semiconductor manufacturing processes. Fourth, the coarse phase control path bypasses the FLL/PLL 412 and is entirely independent of the phase modulator 410. This avoids having to subject the control loop of the FLL/PLL 412 to sudden, large frequency changes.

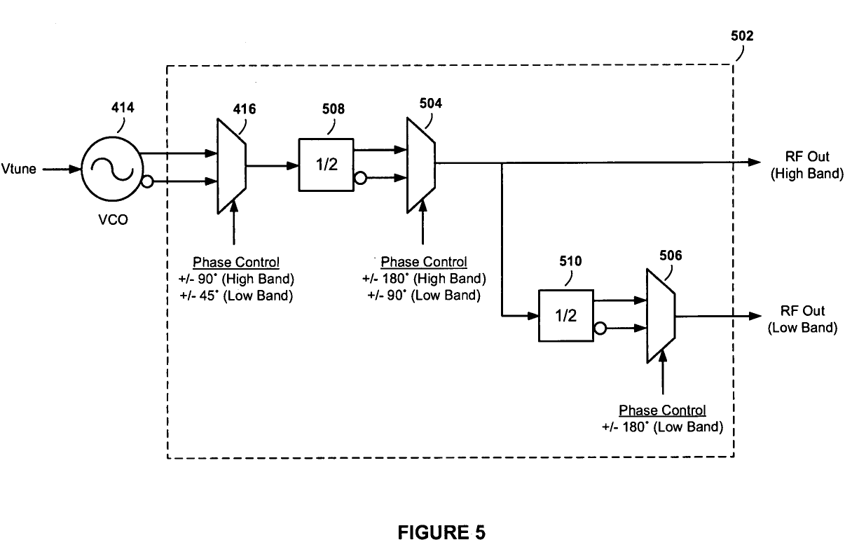

In the methods and apparatus described above, the coarse phase controller 416 is implemented as a phase control switch having the ability to effectuate +180° and −180° phase reversals at the output of the VCO 414. According to another embodiment, illustrated in FIG. 5, a modified coarse phase controller 502 includes second and third phase control switches 504 and 506 and first and second frequency dividers 508 and 510 following the first phase control switch 416. The first and second frequency dividers 508 and 510, which may be implemented using simple toggle flip-flops, operate to divide the frequency of the RF output of the VCO 414 by two and four, respectively. The second and third phase control switches 504 and 506 may be implemented as 2-1 multiplexers, similar to the first phase control switch 416.

Equipped with the additional first and second phase control switches 504 and 506 and first and second frequency dividers 508 and 510, the modified coarse phase controller 502 comprises a quadrature local oscillator generator, providing the ability to configure the polar modulation transmitter 400 for operation in either a “low-band” or a “high-band” operational mode, and the ability to coarsely modify the phase of the VCO output signal at a greater resolution than possible with use of only a single phase control switch 416. Specifically, in addition to ±180° coarse phase reversals, the first and second phase control switches 416 and 504 and first frequency divider 508 allow the phase of the RF output of the VCO 414 to be changed by +90° and −90° for high-band operation. For example, a +90° phase change is made by setting the control signal to the first phase control switch 416 so that the inverting output of the of the VCO 414 is selected, and setting the control signal to the second phase control switch 504 so that the noninverting output of the first frequency divider 508 is selected. A +180° phase change is realized by reversing the values of the control signals to the first and second phase control switches 416 and 504.

Addition of the second frequency divider 510 and third phase control switch 506 provide the ability to change the phase of the VCO output signal by ±45°, ±90° or ±180° for low-band operation. For example, a +45° phase change is made by setting the control signal to the first phase control switch 416 so that the inverting output of the of the VCO 414 is selected, and setting the control signals to the second and third phase control switches 504 and 506 so that the noninverting outputs of the first and second frequency dividers 508 and 510 are selected. A +90° phase change is made by setting the control signal to the second phase control switch 504 so that the inverting output of the of the first frequency divider 508 is selected, and setting the control signals to the first and third phase control switches 416 and 506 so that the noninverting outputs of the VCO 414 and second frequency divider 510 are selected. A +180° phase change is made by setting the control signal to the third phase control switch 506 so that the inverting output of the of the second frequency divider 508 is selected, and setting the control signals to the first and second phase control switches 416 and 504 so that the noninverting outputs of the VCO 414 and first frequency divider 508 are selected.

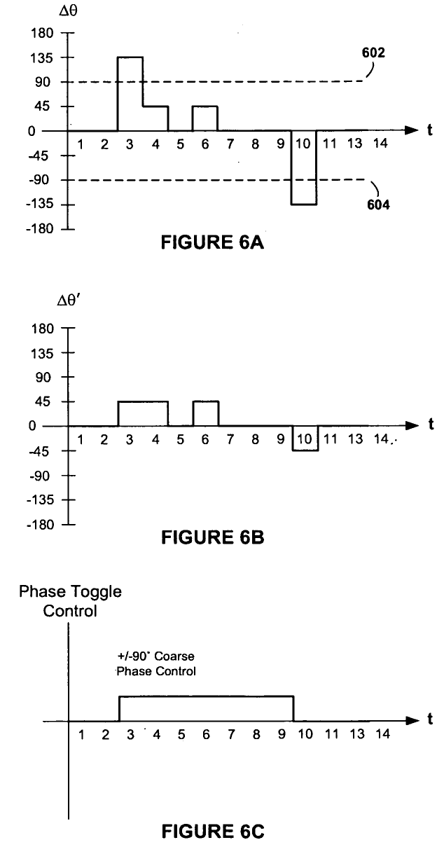

When the polar modulation transmitter 400 is adapted to include the modified coarse phase controller 502 in FIG. 5, the phase difference detector 408 operates to extract phase differences from the phase difference modulation signal Δθ that exceed predetermined upper and lower phase difference thresholds. This approach is illustrated in FIGS. 6A-C, where phase difference thresholds 602 and 604 of +90° and −90° (see FIG. 6A) are used. The phase difference extractor 408 operates to extract the +90° and −90° phase differences to generate the bandwidth-reduced phase-difference modulation signal Δθ′ shown in FIG. 6B. The extracted +90° and −90° phase differences are reintroduced at the output of the VCO 414 by the coarse phase controller 502 in response to the phase toggle control signal shown in FIG. 6C. The remaining phase differences are maintained in the bandwidth-reduced phase-difference modulation signal Δθ′ to provide fine phase control through the phase modulator 410.

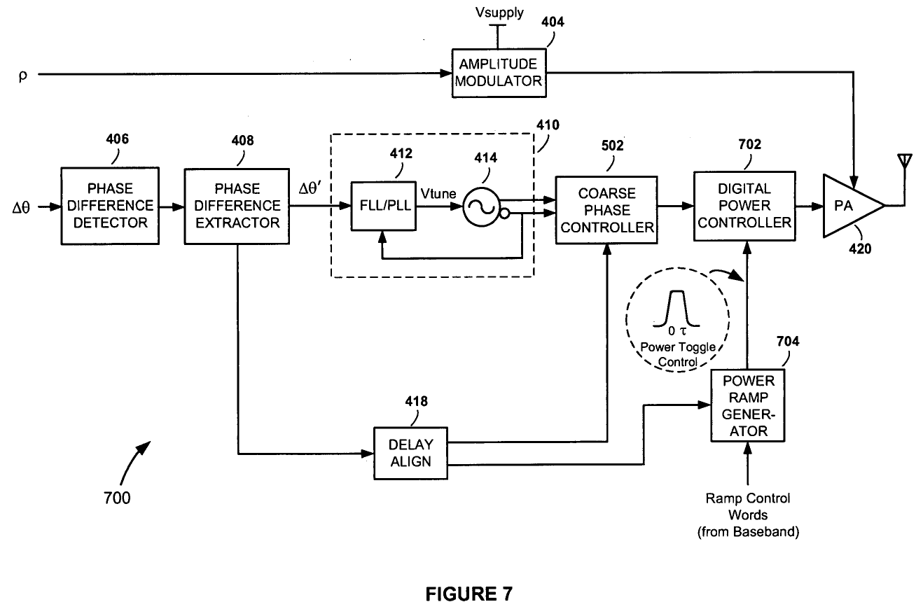

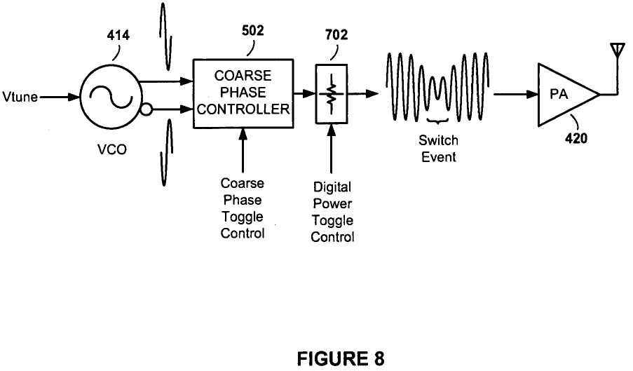

Depending on the application, switching noise generated by fast switching of the phase control switches of the coarse phase controller 502 (or “spectral splatter”) may present a level of adjacent channel interference that is greater than desired. To avoid this problem, a digital power controller 702 can be configured between the output of the coarse phase controller 502 and the input of the PA 420, as illustrated in FIG. 7. The digital power controller 702, which can be implemented using a digitally controlled attenuator, for example, is responsive to a power toggle control signal generated by a power ramp generator 704. The power toggle control signal causes the digital power controller 702 to temporarily reduce the RF power being applied to the input of the PA 420 during times when a phase control switch of the coarse phase controller 502 is switching (i.e., during “switching events”), as illustrated in FIG. 8. The delay align block 418 in the coarse phase control feedforward path is used to ensure that the power toggle control signal and phase toggle control signal are in timed alignment. Backend digital signal processing of the amplitude and phase-difference modulation signals ρ and Δθ affords the ability to know beforehand when a switching event will occur. Accordingly, in preparation of a switching event, the power ramp generator 704 is configured to ramp up and ramp down the power toggle control signal just slightly before and after a switching event, thereby reducing noise generated by the digital power controller 702.

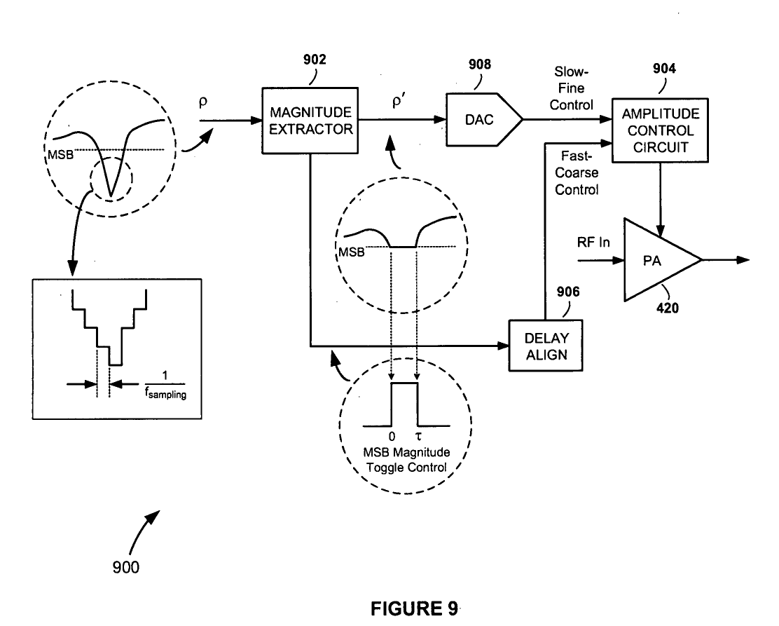

Power control during coarse phase control switching events can also (or alternatively) be performed in the amplitude path of the polar modulation transmitter 400, as illustrated in FIG. 9. As explained above, when the PA 420 is operating in compression, the output power of the PA 420 is determined by the amplitude of the power supply signal being applied to the drain (or collector) of the PA 420. This dependency is exploited in the polar modulation transmitter 900 in FIG. 9, where for ease in illustration the PM path and its various components are not shown.

During operation, a magnitude extractor 902 operates to remove the most significant bit (MSB) from samples of the amplitude modulation signal ρ corresponding to switching events of the coarse phase controller 502. An MSB magnitude toggle control signal generated by the magnitude extractor 902 is fed forward to a fast-coarse control input of an amplitude control circuit 904. The magnitude toggle control signal causes the amplitude control circuit 904 to rapidly reduce the magnitude of the power supply signal being applied to the power supply port of the PA 420 during times when the coarse phase controller 502 is switching. The delay align block 906 ensures that the MSB magnitude toggle control signal is applied at the appropriate coarse phase control switching time. The reduced power supplied to the PA 420 reduces the effects of spectral splatter at the output of the PA 420 caused by the switching of the coarse phase controller 502. Removal of the MSBs from samples of the amplitude modulation signal ρ also produces an amplitude-adjusted amplitude modulation signal ρ′, which is converted to an analog amplitude-adjusted amplitude modulation signal by an amplitude path DAC 908. The amplitude-adjusted amplitude modulation signal ρ′ is coupled to a slow-fine control input of the amplitude control circuit 904, and used to control the slew rate of the amplitude modulated power supply signal appearing at the output of the amplitude control circuit 904 just prior to and after times when the coarse phase controller 502 is switching.

Although the present invention has been described with reference to specific embodiments, these embodiments are merely illustrative and not restrictive of the present invention. Further, various modifications or changes to the specifically disclosed exemplary embodiments will be suggested to persons skilled in the art and are to be included within the spirit and purview of this application and scope of the appended claims.

What is claimed is:

1. A modulator apparatus for a polar modulation transmitter, comprising:
an extractor configured to extract coarse modulation information from a modulation signal to generate a bandwidth-reduced modulation signal;
a fine modulation controller configured to generate a modulated radio frequency (RF) carrier signal using said bandwidth-reduced modulation signal; and
a coarse modulation controller configured to modify the modulated RF carrier signal according to coarse modulation information extracted from said modulation signal by said extractor.

2. The modulator apparatus of claim 1 wherein said extractor comprises a phase reversal extractor configured to extract +180° and −180° phase differences represented in said modulation signal, and said coarse modulation controller comprises a phase reversal controller configured to effectuate phase reversals in the modulated RF carrier signal corresponding to +180° and −180° phase differences extracted from said modulation signal by said phase reversal extractor.

3. The modulator apparatus of claim 2 wherein said fine modulation controller comprises a phase modulator including a controlled oscillator with a differential output, and said phase reversal extractor comprises a switch operable to select between inverting and noninverting outputs of the differential output depending on the polarity of the +180° and −180° phase differences extracted from said modulation signal.

4. The modulator apparatus of claim 1 wherein said extractor comprises a phase difference extractor configured to extract sample-to-sample phase differences represented in said modulation signal that exceed a predetermined phase difference threshold, and said coarse modulation controller comprises a coarse phase controller configured to coarsely control the phase of the modulated RF carrier signal generated by said fine modulation controller according to phase differences extracted from said modulation signal.

5. The modulator apparatus of claim 4 wherein said coarse modulation controller comprises a quadrature local oscillator generator.

6. The modulator apparatus of claim 1, further comprising:
a power amplifier (PA) having an RF input; and
a digital power controller coupled between an output of said coarse modulation controller and the RF input of said PA, said digital power controller operable to reduce the amplitude of a phase-modulated RF signal applied to the RF input of the PA during a time when the coarse modulation controller is switching.

7. The modulator apparatus of claim 6, further comprising a power ramp generator configured to generate a power control signal that causes the digital power controller to ramp the amplitude of the phase-modulated RF signal applied to the RF input of the PA down or up prior to or after the time when the coarse modulation controller is switching.

8. The modulator apparatus of claim 1, further comprising:
a power amplifier (PA) having a power supply port; and
an amplitude controller operable to reduce the amplitude of a power supply signal applied to the power supply port of the PA during a time when the coarse modulation controller is switching.

9. The modulator apparatus of claim 8, further comprising circuitry for controlling a slew rate at which the power supply signal applied to the power supply port of the PA is reduced prior to or after the time when the coarse modulation controller is switching.

10. A polar modulation method, comprising:
removing coarse modulation information represented in a modulation signal in a phase modulation path of a polar modulation transmitter to generate a bandwidth-reduced modulation signal;
finely modulating a radio frequency (RF) carrier signal with said bandwidth-reduced modulation signal to produce a finely modulated RF carrier signal;
coarsely modulating the finely modulated RF carrier signal according to coarse modulation information removed from said modulation signal to generate a finely and coarsely modulated RF carrier signal; and
coupling the finely and coarsely modulated RF carrier signal to an RF input of a power amplifier (PA).

11. The polar modulation method of claim 10 wherein removing coarse modulation information represented in said modulation signal comprises removing +180° and −180° phase differences represented in said modulation signal, and coarsely modulating the finely modulated RF carrier signal comprises introducing phase reversals in said finely modulated RF signal according to +180° and −180° phase differences removed from said modulation signal.

12. The polar modulation method of claim 11 wherein finely modulating the RF carrier signal with said bandwidth-reduced modulation signal comprises producing a noninverting finely modulated RF carrier signal and an inverting finely modulated RF carrier signal, and introducing phase reversals in said finely modulated RF signal comprises switching between the noninverting and inverting finely modulated RF carrier signals.

13. The polar modulation method of claim 10 wherein coarsely modulating the finely modulated RF carrier signal further comprises:
inverting the finely modulated RF carrier signal and dividing the frequency of the inverted finely modulated RF carrier signal to effectuate a first coarse phase change; and
dividing the frequency of the finely modulated RF carrier signal and inverting the divided finely modulated RF carrier signal to effectuate a second phase change.

14. The polar modulation method of claim 10 wherein removing coarse modulation information represented in said modulation signal comprises removing phase differences that exceed a predetermined phase difference threshold, and coarsely modulating said finely modulated RF carrier signal comprises modifying the phase of the finely modulated RF signal according to remove phase differences exceeding the predetermined phase difference threshold.

15. The method of claim 10, further comprising reducing the amplitude of the finely and coarsely modulated RF carrier signal during coarsely modulating the finely modulated RF carrier signal.

16. The method of claim 15, further comprising ramping the amplitude of the finely and coarsely modulated RF carrier signal down or up prior to or after coarsely modulating the finely modulated RF carrier signal.

17. The method of claim 15, further comprising reducing the amplitude of a power supply signal applied to a power supply port of the PA during coarsely modulating the finely modulated RF carrier signal.

18. The method of claim 10, further comprising reducing the amplitude of a power supply signal applied to a power supply port of the PA during coarsely modulating the finely modulated RF carrier signal.

19. The method of claim 18, further comprising controlling a slew rate at which the power supply signal applied to the power supply port of the PA is reduced prior to or after coarsely modulating the finely modulated RF carrier signal.

20. A polar modulation transmitter, comprising:
means for generating an amplitude modulated power supply signal in an amplitude modulation path;
means for extracting coarse phase change information represented in a modulation signal in a phase modulation path to generate a bandwidth-reduced modulation signal;
means for generating an RF carrier signal;
means for modulating the RF carrier signal according to phase change information represented in said bandwidth-reduced modulation signal to produce a phase-modulated RF carrier signal;
means for altering the phase of the phase-modulated RF carrier signal to account for coarse phase change information extracted from said modulation signal to produce an altered phase-modulated RF carrier signal; and
means for amplifying the altered phase-modulated RF carrier signal.

21. The polar modulation transmitter of claim 20 wherein said means for extracting coarse phase change information comprises means for extracting +180° and −180° phase changes represented in said modulation signal.

22. The polar modulation transmitter of claim 20 wherein said means for extracting coarse phase change information represented in said modulation signal comprises means for extracting coarse phase changes that exceed a predetermined coarse phase change threshold.

23. The polar modulation transmitter of claim 22 wherein said means for altering the phase of the phase-modulated RF carrier signal includes means for altering the phase of the phase-modulated RF carrier signal by a plurality of different phase change values.

24. The polar modulation transmitter of claim 20, further comprising means for controlling the amplitude of the altered phase-modulated RF carrier signal during times when said means for altering the phase of the phase-modulated RF carrier signal is operating to account for the coarse phase change information extracted from said modulation signal.

25. The polar modulation transmitter of claim 20, further comprising means for controlling the amplitude of the amplitude modulated power supply signal during times when said means for altering the phase of the phase-modulated RF carrier signal is operating to account for the coarse phase change information extracted from said modulation signal.
